(19) United States
(12) Patent Application Publication
(10) Pub. No.: US 2013/0226810 A1
(43) Pub. Date: Aug. 29, 2013

(54) SYSTEM AND METHOD FOR CERTIFYING A WILL

(71) Applicant: Wayne Moffett, Lake Worth, FL (US)

(72) Inventor: Wayne Moffett, Lake Worth, FL (US)

(21) Appl. No.: 13/404,443

(22) Filed: Feb. 24, 2012

(51) Int. Cl. G06Q 99/00; H04L 9/28

(52) U.S. Cl. 705/50; 705/317

(57) ABSTRACT

A system for certifying the status of a will having a security device adapted to be affixed to a will. A server creates an account reference number and a version identification; the version identification corresponds to a version of a will to which the security device is affixed The security device contains information, which includes at the least one of the account reference number and the version identification. A remote computing device communicates with the server and communicates information contained in the security device to the server. A database communicates with the server and stores the version identification and account reference number. The server maps the version identification to the account reference number. A system that will locate the last and legitimate will regardless of which version of the will is initially referenced.

### BACKGROUND OF THE INVENTION

The present invention is directed to a system for probating an estate and in particular, a system for authenticating a will.

Once a person dies, their assets (the estate) may be subject to probate. Probate is the legal process by which a person's final debts are settled and legal title to property is formally passed from the decedent to his or her beneficiaries and heirs. This formal process is dependent on the presence of a legitimate will. Many wills are never executed because they are never found. Even after a will is found, it must be confirmed as the last will of the decedent before it can be executed, or it could be contested. A contested will could mean costly delays to the distribution of assets and additional work for the Executor of an estate.

Once a will has been probated, the next major responsibility of an Executor is to inventory the assets and liabilities of the decedent. If proper records of such items are not located, this could be a long and arduous process. The decedent's liabilities must first be settled before the remaining assets can be distributed to their beneficiaries.

Reference is now made to FIG. 1 in which the method for delivering a will in accordance with the prior art is provided. In accordance with the prior art, the will may be in the possession of the decedent, in a drawer in the house, in a safe deposit box, in their office, or anywhere. In some instances, the will is left in the safekeeping of the lawyer who drafted the last version of the will. However, there is no central depository for the will.

More specifically in accordance with the prior art, the Testator, the person creating the will, creates, modifies or voids an existing will in a step 100. However, there is no additional record that this transaction has occurred. If the Testator wishes to disclose the location of the will, then in a step 102 the Testator may inform others, such as the designated Executor of the estate, relatives, or third parties who have no interest in the will, such as a trusted business partner, lawyer, accountant or the like. If the Testator wishes to register the will for future reference, then in a step 103 the Testator may register the will at a local registry by merely indicating that a will was deposited at a location on a certain date. In step 104, the Executor retrieves the will from the registry or other storage place of which they are aware. This leaves the Executor in a precarious state of wondering if additional wills exists.

The common practice is to use the last presented and dated will as the one to be executed. This may not necessarily be the decedent's final and legitimate wishes. Compounding the process further, in many cases, the list of assets captured in the will is not an exhaustive list. This is often a source of angst for Executors.

The prior art system has been satisfactory for centuries. However, as can be seen, there is no centralized or coordinated record of each version of any will. In a more transient society in which people are living longer and moving between several locations during their lifetime, the prior art provides little comfort as to the completeness or accuracy of the information to confirm that any will in the possession of the Executor is in fact the final will.

Another subtle issue that should not be overlooked is the one of privacy. Many wealthy decedents often avoid probating their wills because their wills eventually become public domain as part of the probate process, openly publicizing their assets listed within the document. This can lead many that are privacy conscious to avoid the very process that's in place to assist them.

This prior art method of delivering a will and preparing an Executor has been satisfactory. However, the prior art process suffers from the deficiency that it is inefficient and error prone, and as a result does not allow the last wishes of the decedent to be executed. As a result, many wills are never found to be executed. Further, many wills are contested due to uncertainty of its status as last legitimate will. These issues can add substantial delays to the probate process and execution of the decedent's final wishes.

Assuming a legitimate will has been probated, wills are often generic in their description of assets and the Executor may still face major obstacles in locating documents, accounts, liabilities and assets that must be settled prior to distribution of remaining assets. The process of locating such items is often the source of substantial delays to the execution of the decedent's final wishes.

Accordingly, a system and method which overcomes these deficiencies of the prior art are desired.

### BRIEF SUMMARY OF THE INVENTION

The system consists of a secured database containing data corresponding to each version of a person's will. Information correspond to the existence of the original will along with modifications thereto are stored in this database. Each modification is registered into the database, with a summary of changes, as a distinct version of the will. A server associated with the database assigns a unique reference number (Account Reference Number) to each Testator. The server assigns a new version identification (ID) to each version of the will. A remote computer communicates with the server allowing an Executor to access the database with the Account Reference Number, providing access to the full history of the will including modifications; confirming the final and legitimate will of any registered Testator.

During operation as each new version of the will is entered in the database, the Testator is given a certified security device, including but not limited to security seal, consisting of a unique reference number which consists of both the Reference Account Number and the version ID of the current version of the will. This security device is affixed to the physical will identifying the respective version of the will as a certified will, and identifying the will's specific version along with its Account Reference Number. The security device is tamper resistant, to maintain integrity and prevent the device from being transferred to another document after its original deposit. A security seal is one such implementation of a passive security device. The security device may also be an active electronic device or other token, having a unique pin.

Along with each version of the will stored in the database, the physical location of the signed and legitimate document is recorded in the database. Therefore, the Testator Account Number is used to access the database and is sufficient to locate all outstanding versions of wills, including the final and legitimate will needed for a speedy probate process.

In one embodiment, the information stored in the database may be encrypted. In such a case, the Testator generates a security key from the database that is printed but hidden on the security device affixed to the will for later legitimate use. This security key created by the Testator is used to encrypt any sensitive information. For example, if the inventory feature of the database is used, the details of the inventory could be hidden for later use by the Executor.

In this case, the Executor must first retrieve the security key from the will's security device, enter the key directly at the server to decrypt the full details of the decedent's estate in the database. The security key must be hidden in a tamper proof portion of the security device for security reasons. If the tamper proof portion of the security device has been voided prior to legitimate use, the information could be rendered useless for decryption on the database. If the Testator wishes, the database operator must first verify the death of the Testator and assignment of an executor, via the receipt of a valid Letter Testamentary before activating the security key.

The Testator may optionally protect their assets from being openly publicized in the probate process. To obtain this privacy protection, the Testator must reference the database in the Will's residual clause, with wording such as “all other assets intentionally and privately listed with database . . . ”. These assets explicitly excluded from the Will, but captured in the database, will not be subjected to free and open public access.

The Testator can also optionally add a list of beneficiaries to be notified upon their death. The Executor would be permitted by the database operator to trigger such a notification after the Letter Testamentary has been verified by the operator.

### BRIEF DESCRIPTION OF THE DRAWINGS

For a fuller understanding of the invention, reference is had to the following description taken in connection with the accompanying drawings in which:

FIG. 1 is an operational diagram of the method for registering a will in accordance with the prior art;

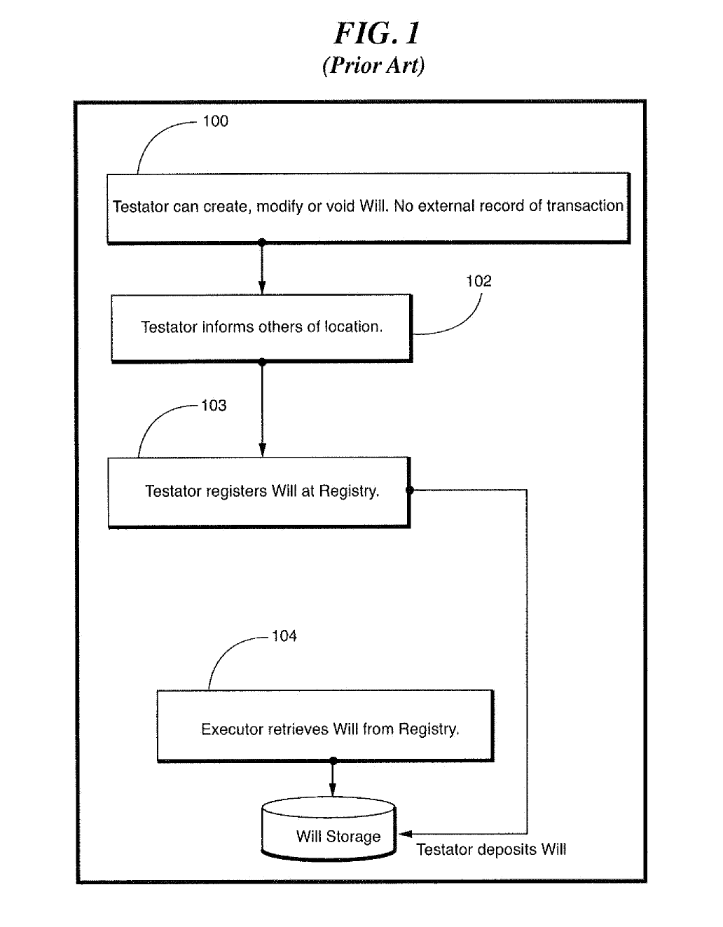

FIG. 2 is a schematic diagram of a system operating in accordance with the invention;

FIG. 3 is a flow chart showing the process for a Testator certifying a will with the system in accordance with the invention;

FIG. 4 is a flow chart showing the process for an Executor interacting with the system in accordance with the invention; and

FIG. 5 is a flow chart of the manner in which the system certifies the status of a will in accordance with the invention.

### DETAILED DESCRIPTION OF THE INVENTION

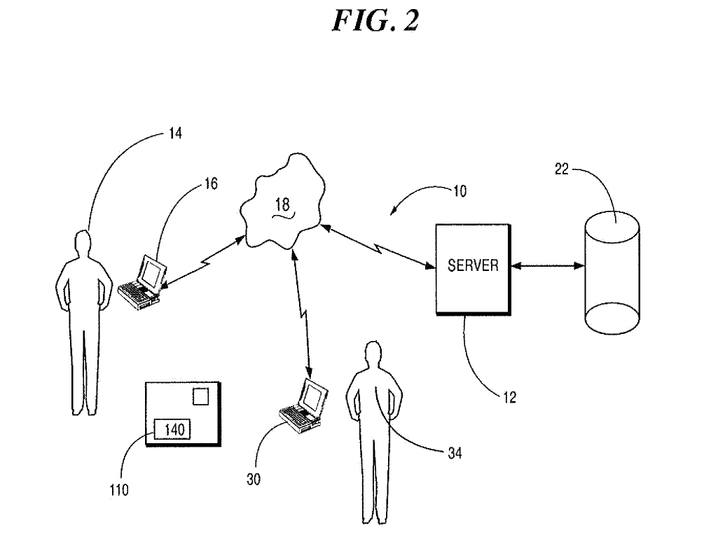

Reference is now made to FIG. 2 in which a system, generally indicated as 10 for registering a will in accordance with the invention is provided. System 10 includes a server 12 operatively communicating with a database 22. Server 12 communicates with a Decedent (Testator)14, or the authorized representative, such as an attorney, through a first input device 16, such as a remote computer, through internet 18. Server 12 may also communicate with an Executor 34 through a second remote computing device 30.

In a preferred embodiment, server 12 provides an interactive web based portal such as a web page for interacting with the Testator 14 and Executor 34. However, it should be noted that computer 16, 30 may be any interactive device which allows each of Testator 14 and Executor 34 to interact with server 12 utilizing functionality described below. It should be noted that the preferred embodiment is an Internet based system to facilitate the use of server 12. However, the computing device 16, 30 may be anything compatible with the electronic transfer of information with server 12 to be stored and/or retrieved from database 22, including handheld personal data accessories, tablets, laptop computers, smart cellular phones, or the like by way of non-limiting embodiment.

Database 22 stores the instructions for the operation of server 12 as discussed below, as well as the transactional information such as the description of a will, a scanned image of the will, a time stamp of the will, the associated identification information associated with the will as will be discussed below, by way of non-limiting example. The information may also include log in identity and passwords of the system users to facilitate protection of the data stored in database 22. By way of non-limiting example, database 22 may store any or all of descriptive information of the will, a history of modifications to the will, a date stamp associated with each modification of the will, and the deposit date of each version of the will, assets associated with the Testator 14 that are not specifically mentioned in the will, and identification information for identifying an Executor 34 and a Testator 14, even if the Executor 34 is unaware that they have been named as an Executor. Actual copies of the will may be scanned in to system 10 and saved in database 22 for further verification, and authentication.

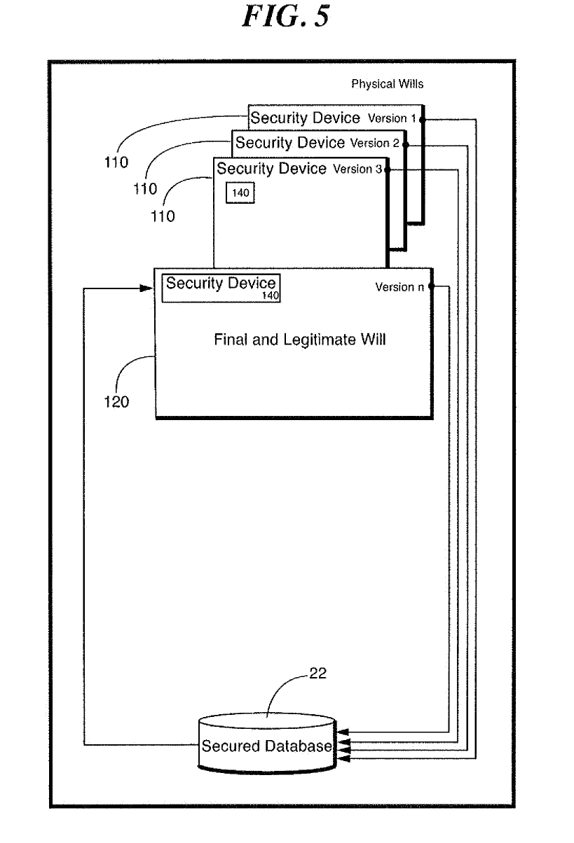

System 10 may also be considered to include the physical elements of the security devices affixed to the will. Reference is now made to FIG. 5, in which the system 10, showing the electronic and physical components of the invention is provided. The invention of system 10 operates on wills 110 which have physical real world component which Testator 14 and Executor 34 use to interact with system 10. Each will 110 includes a security device 140 which will be described in detail below. Security device 140 is a physical item associated with, and to be physically attached to, each version of will 110.

In accordance with the invention, versions of the physical will 110, 120 including older versions of the will 110 and the last version of the will 120 are each affixed with a security device 140. Information regarding wills 110, and most recent will 120, including information for recognizing decoding, and/or authenticating security device 140 associated with a respective will 110, 120 are stored in certified database 22. The security device 140 provides security features that ensure the physical security device is not transferable from document to document. Each security device 140 is associated with a unique Account Reference Number associated with Testator and Version ID associated with each will version 110, 120.

During the process, server 12 creates Version IDs and Account Reference Numbers, for each will 110, 120 and Testator 14. Server 12 using the information stored in database 22 will manage the version control of all versions of will 110, 120 associated with each Testator. Database 22 stores the unique Account Reference Number which identifies each Testator and the Version ID mapped the Account Reference Number to identify each version of a will 110, 120 corresponding to Testator 14. Database 22 will also have the capability to host additional information mapped to the Account Reference Number of Testator 14, the Executor 34, the old versions of will 110, 120 the latest version of will 120 or each Security Device 140. Server 12 uses this information stored in database 22 to process each will 110, 120 and enable use of the system by Testator 14 or Executor 34.

The mechanics of using the enhanced system can be broken into two primary phases. First, the Testator 14 interacts with system 10 to register and enter information to assist the Executor 34 in their fiduciary duties. Second, the Executor 34 interacts with system 10 to obtain relevant information for the purposes of their fiduciary duties.

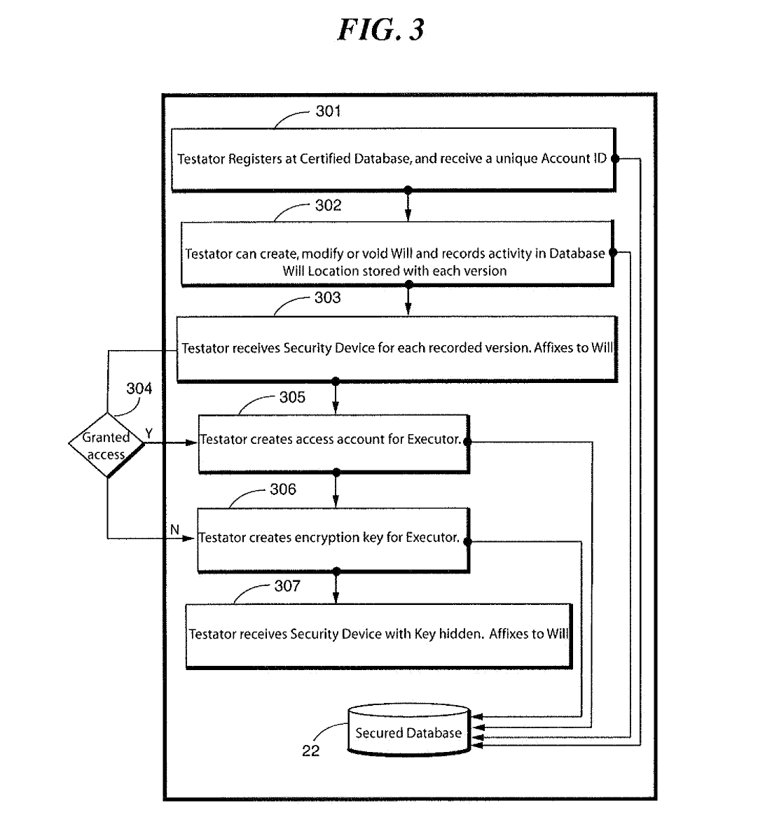

The process begins with a Testator 14 registering a will 110, 120 with system 10 to be stored in database 22. Reference is made to FIG. 3 in which flow chart for registering a will 120 in accordance with the invention is provided. In a step 301 Testator 14 registers with the system 10 from remote computing device 16. Server 12 creates a unique Account Reference Number for the Testator. This Account Reference Number is used by server 12 to uniquely identify Testator 14 on a permanent basis, and is stored in database 22, and transmitted to remote computing device 16 for future use by Testator 14.

In a step 302, Testator 14 creates, modifies or voids their will 110 and server 12 records each such activity in database 22 as a unique transaction. Server 12 creates a Version ID to identify each unique transaction. Each transaction consists of a unique Version ID and a description of each transaction which are stored in database 22 mapped to the Account Reference Number. The physical location of a will 110, 120 may also be stored, in a preferred exemplary embodiment, with each Version ID and description in database 22. At this point, Testator 14 may also store an inventory of assets mapped to the Account ID as a separate file in database 22.

In a step 303 Testator 14 receives a security device 140 for each recorded version of will 110, 120. Security device 140 may take the form of a barcode or other optical code to be printed by a computing device 16 on will 110, 120, or otherwise affixed to will 110, 120. Testator 14 must affix security device 140 to the will 110. This identifies the will 110 as certified, and identifies the Testator 14 and the specific version of the physical will 110. This is of particular importance to the Executor 34 during the probate process. The operator of the system 10 manages and distributes the security devices 140 as needed.

It is determined in a step 304 whether Executor 34 is to be given access to system 10 during the lifetime of Testator 14. If Testator 14 wishes the Executor 34 to have immediate access to the stored information, Testator 14 creates an access account in step 305 for the Executor 34. This allows Executor 34 to view information created by the Testator 14 in advance of probate. At a minimum, Testator 14 should inform the Executor 34 of their use of the system 10 and the information stored within database 22, as this is the preferred method of guidance for locating the most recent (valid) will 120 needed as part of the probate process.

If in step 304, Testator 14 wishes the Executor 34 to be aware that certain pieces of information exist without disclosing the actual information, the Testator 14 could, in a step 306, encrypt portions of the information stored in database 22. Testator 14 creates an encryption key to be operated upon by server 12. This allows Executor 34 to know the existence of current will 120 in advance of the probate process, without disclosing the actual information. This information could be fully revealed during the probate process, by using the encryption key to decrypt the information stored in database 22. In one non-limiting example, the encryption key is recorded but hidden on security device 140.

In a step 307 Testator 14 receives the security device 140 with hidden encryption key for each recorded version of will 110, 120 at remote computer 16. Testator 14 must affix the security device 140 to the most recent will 120. This identifies the will 120 as certified, identifies the specific version of the physical will 120, and if necessary, provides a hidden encryption key that could be used to decrypt data stored in database 22 to fully reveal information during the probate process. This is of particular importance to the Executor 34 during the probate process. In one preferred embodiment, the security device 140 provides tamper proof capabilities to protect the hidden encryption key until it is needed at time of probate.

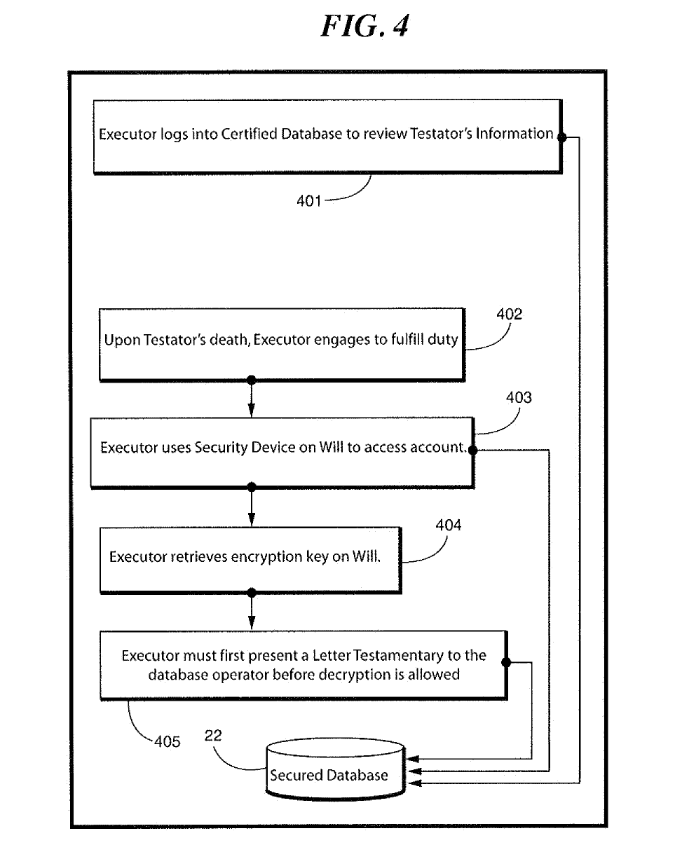

Reference is now made to FIG. 4, in which the process for Executor 34 making use of system 10 in accordance with the invention is provided. As a result of the configuration of database 22 by Testator 14, Executor 34 simply accesses database 22 to obtain the stored information. The location of each version of will 110, 120 has been captured and stored in this central secured certified database 22 as discussed above. The information in the certified database 22 provides a clear history of current will 120 along with the physical location of the most recent (valid) will 120 needed for execution.

Specifically in Step 401, Executor 34 accesses certified database 22 at any point in time from remote computing device 30. If Testator 14 has permitted an access to the account to allow previews of the information, Executor 34 will have immediate access to the information. Otherwise, Executor 34 would initiate access to the database 22 as part of their fiduciary duties upon the death of the Testator 14. In a preferred embodiment, the existence of certified database 22 would be referenced by the security device 140 attached to the physical will 120, should the other preferred referencing mechanisms fail. In addition, server 12 would enable searching of database 22 for the presence of an account for Testator 14 as a last resort, which would allow Executor 34 to determine whether a decedent had registered his or her will 110, 120 with system 10.

Upon the Testator's death in a step 402, the Executor 34 communicates with certified database 22 to gain access to the stored information in database 22 in order to fulfill their fiduciary duties.

If Executor 34 had not previously accessed the database 22, in a step 403, the Account Reference Number on the security device 140 of the physical will 120, may also be used to gain access to system 10 by way of electronic key input, password entry, biometric scanner, code scanner, or the like at computing device 30.

If the decedent had previously encrypted information for privacy or security, then in a step 404 the encryption key on the security device 140 of the physical will 120 is used to gain access to the encrypted information in database 22. Since encrypting information is often an additional precautionary step for privacy or security purposes, in a step 405, Executor 34 presents some form of verification to an operator of the system 10 that confirms the death of Testator 14 to fully enable the decryption capability. This verification could be a Death Certificate or a Letter Testamentary. With this capability, the Executor would now have full access to all information stored by the decedent.

Certified database 22 now holds records of all versions of the will 110, 120 including older versions of the will 110 and the last version of the will 120, fully telling the story for each Testator 14. In a preferred non-limiting embodiment, each version of the will 110, 120 possesses a security device 140 referencing the certified database 22, its unique Account Reference Number and version ID of the physical will. Therefore, finding any version of the will 110, 120 can provide a complete story of will 110, 120 through system 10 and the information in database 22. This system will obviously confirm the last and legitimate will 120 that should be used in the probate process as the final version is easily identified by use of system 10.

By providing a system and database as described, the present system allows the Testator an opportunity to optionally inventory their assets in a single secure location. This provides a vehicle for the Executor to easily find the assets in question for distribution to the Testators' heirs. The asset list is automatically associated with the current versions of the Will, allowing the Executor to better understand when assets were added or removed from the Testators' concerns. The asset list is also a controlled entity managed with automatically recorded date and timestamps, and can be associated with the current legitimate version of the Will. These detailed records could be used for clarification purposes in cases of disputes.

Thus, while there have been shown, described and pointed out, novel features of the present invention as applied to preferred embodiments thereof, it will be understood that various omissions and substitutions and changes in the form of detail are contemplated to the disclosed invention which may be made by those skilled in the art without departing from the spirit and scope of the invention. It is the intention therefore to be limited only as indicated by the scope of claims appended hereto. It is also to be understood that the following claims are intended to cover all the generic and specific features of the invention herein described and all statements of the scope of the invention, which as a matter of language, might be said to fall therebetween.

What is claimed is:

1. A system for certifying the status of a will comprising:
a security device adapted to be affixed to a will;
a server, the server creating an account reference number and a version identification, the version identification corresponding to a version of a will to which the security device is affixed, the security device containing information, the information including at the least one of the account reference number and the version identification;
a remote computing device communicating with the server and communicating information contained in the security device to the server; and
a database communicating with the server and storing the version identification and account reference number, the server mapping the version identification to the account reference number.

2. The system of claim 1, further comprising transaction information stored in the database, the transaction information corresponding to respective version of the will to which the security device is attached.

3. The system of claim 1, further comprising asset information corresponding to assets of a Testator, the asset information being stored in the database, the server mapping the asset information to the account reference.

4. The system of claim 1, wherein at least one of a location of the will, a list of assets associated with the will, and notification information for beneficiaries of the will are stored in the database and are mapped to the account reference.

5. The system of claim 4, further comprising an encryption key stored in the security device wherein at least one of the location of the physical will, the list of assets associated with the will, and notification information are stored as encrypted data in the database.

6. A method for certifying a will comprising:
providing a security device adapted to be affixed to a will;
providing a server and a database associated with the server;
registering a testator with the server, the server creating an account reference number and storing the account reference number in the database;
registering a will associated with the account reference number with the server, the server creating a version identification for each version of the will and mapping the account reference number to the version identification; and
creating a security device as a function of the account reference number and the version identification, and storing the account reference number and the version identification in the security device.

7. The method of claim 6, further comprising the steps of storing asset information in the database, the server mapping the asset information to at least one of the account reference number and the version identification.

8. The method of claim 6, further comprising the step of an executor utilizing the security device to access the database and determine the existence of a will; and utilizing the security device to confirm the version of the will to which the security device is affixed.

9. The method of claim 6, further comprising creating an at least second will;
the server creating an at least second version identification corresponding to the at least second will; and creating an at least second security device as a function of the account reference number and the at least second version identification, and affixing the at least second security device to the at least second version of the will.

10. The method claim 6, wherein the security device is a tamper proof device.

11. The method of claim 8, further comprising the step of the server providing a history of at least a second version of the will.
